(19) United States
(12) Patent Application Publication
(10) Pub. No.: US 2003/0228864 A1
(43) Pub. Date: Dec. 11, 2003

(54) Server

(76) Inventor: Keisuke Tanaka, Kanagawa-ken (JP)

Correspondence Address: BIRCH STEWART KOLASCH & BIRCH, PO BOX 747, FALLS CHURCH, VA, 22040-0747, US

(21) Appl. No.: 10/422,727

(22) Filed: Apr. 25, 2003

(30) Foreign Application Priority Data
Apr. 26, 2002 (JP) 125326 / 2002

(51) Int. Cl. H04Q 7/20

(52) U.S. Cl. 455/422.1; 455/414.1; 455/445

(57) ABSTRACT

Order reception involving a cellular phone is improved. When an access from a cellular phone is received, an order reception unit in a print server searches a second storage unit for an unconfirmed printing order request regarding the phone number of the cellular phone. If the unconfirmed printing order request is found, the unconfirmed printing order request is displayed in the form of an order confirmation page to enable a user to resume input of the printing order request.

### BACKGROUND OF THE INVENTION

1. Field of the Invention

The present invention relates to a server used for providing an order reception service to a mobile terminal via a network.

2. Description of the Related Art

Following the spread of the Internet, orders are placed more and more via a network. For example, a user at home can access a server on the Internet for on-line shopping or for network banking from his/her personal computer. Furthermore, mobile terminals such as cellular phones are spreading rapidly, and it has become common to place an order via a network such as the Internet by accessing a server on the network with use of a mobile terminal instead of a personal computer.

However, mobile terminals such as cellular phones have screens that are smaller than those of personal computers, since mobile terminals are designed to be portable. Therefore, unlike a personal computer, not all items can be displayed at once on a mobile terminal for an input of quantity or the like for each item when an order is placed through an access to a server on the Internet. Consequently, each of or a few of the goods are displayed in one page, and pages need to be changed for placing an order. Especially, in the case of placing an order for printing image data stored in a print server through an access to the print server, the number of items to be input, such as a quantity, a print size, and presence or absence of eclipse, is large. In addition, the goods (the image data in this case) need to be confirmed. Therefore, reduction of a size of the goods to be displayed is not preferable. For this reason, it is more time-consuming for a cellular phone to place an order via a network than for a personal computer.

Meanwhile, a mobile terminal such as a cellular phone is used more as voice communication equipment rather than communication equipment via a network (such as accessing the Internet). When a phone call is received while a user is carrying out a comparatively time-consuming order procedure such as inputting the content of an order while accessing a server, the incoming call has priority. Therefore, the communication between the mobile terminal and the server is interrupted. If the time of interruption exceeds a predetermined time, the server usually disconnects the communication with the mobile terminal due to time-out. Consequently, information representing the content of the order that has been input by the user of the terminal before the disconnection is erased and the user has to repeat the same procedure upon reorder. In this manner, users have been troubled.

### SUMMARY OF THE INVENTION

The present invention has been conceived based on consideration of the above circumstances. An object of the present invention is therefore to provide a server for realizing an order reception service that is beneficial to a user who places an order from the server on a network with use of a mobile terminal.

A server of the present invention is a server that can provide an order reception service to a mobile terminal, and the server comprises:

connection means for connecting with the mobile terminal via a network;

reception means for receiving an order request and a confirmation instruction regarding the order request input by a user via the mobile terminal connected by the connection means;

unconfirmed order request retaining means for retaining the content of the order request of the user until the confirmation instruction regarding the order request is input by the user via the mobile terminal; and

order reception means for receiving an order according to the content of the order request confirmed by the confirmation instruction input by the user via the mobile terminal. In the server, the order reception means comprises:

search means for checking whether or not the unconfirmed order request retaining means has an order request that has not been confirmed by the user of the mobile terminal upon connection with the mobile terminal established by the connection means; and

unconfirmed order request retrieving means for providing the user via the mobile terminal with the order request that has not been confirmed by reading the order request of the user retained in the unconfirmed order request retaining means in the case where the unconfirmed order request retaining means has the order request of the user.

The server of the present invention may further comprise storage means for storing image data so that the server can be used as a printing service server that provides a service of receiving a printing order request regarding the image data stored in the storage means.

The connection means in the server of the present invention refers to an interface for connecting with the mobile terminal via the network such as the Internet, and may include user authentication means in the case where the server carries out user authentication.

The order request refers to an input that is necessary for placing an order for goods, such as specification of the goods for which the user is placing the order (such as the name, a color, a size, and a quantity thereof), the date of delivery thereof, a reception method, and a settlement method. In the case where the server is the printing service server described above, the order request refers to specification of the image data to be printed, printing instructions such as a print size, a quantity, and presence or absence of eclipse, and methods of print reception and settlement, for example.

The confirmation instruction refers to an instruction for confirming the order request. Depending on a configuration of the server, the confirmation instruction may be input by clicking a button such as “Confirm”, “Decide”, or “Order” in a Web page, for example.

### BRIEF DESCRIPTION OF THE DRAWINGS

FIG. 1 is a block diagram showing a configuration of a printing service system according to an embodiment of a server of the present invention;

FIG. 2 is a block diagram showing a configuration of a print server 100 in the printing service system shown in FIG. 1;

FIG. 3 shows an order reception page displayed by an order reception unit 115 of the print server 100 shown in FIG. 2;

FIG. 4 shows a page for inputting a printing order request regarding an image displayed by the order reception unit 115 of the print server 100;

FIG. 5 shows an order confirmation page displayed by the order reception unit 115; and

FIG. 6 is a flow chart showing the operation of the print server 100.

### DESCRIPTION OF THE PREFERRED EMBODIMENT

Hereinafter, an embodiment of the present invention will be explained with reference to the accompanying drawings.

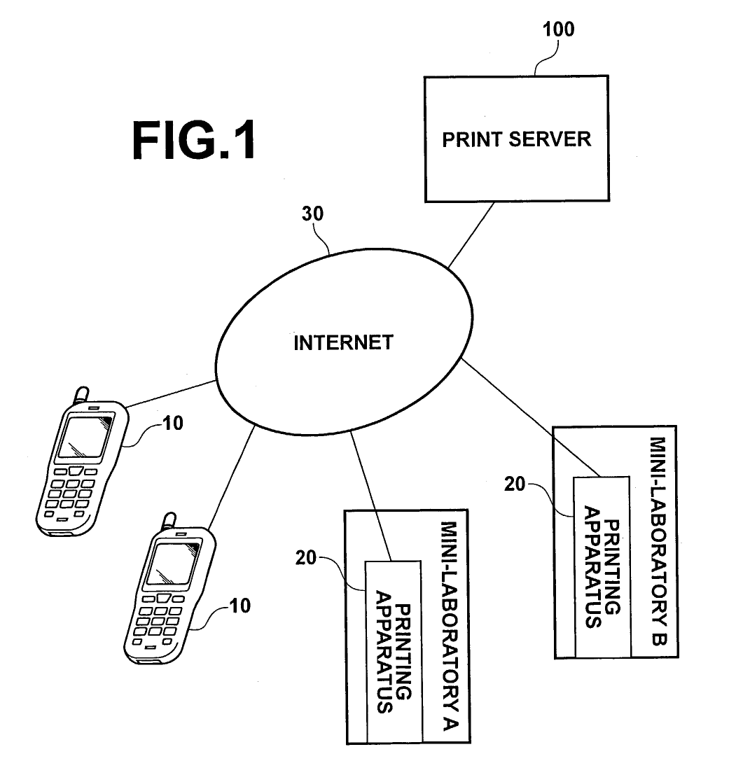

FIG. 1 is a block diagram showing a configuration of a printing service system according to an embodiment of a server of the present invention. As shown in FIG. 1, the printing service system in this embodiment comprises a cellular phone 10 acting as a mobile terminal, a print server 100 that stores image data and provides a printing service regarding the image data, and printing apparatuses 20 that are respectively installed in mini-laboratories and print the image data regarding which printing orders are received by the print server 100. The cellular phone 10, the print server 100, and the printing apparatuses 20 in the mini-laboratories are connected via the Internet 30.

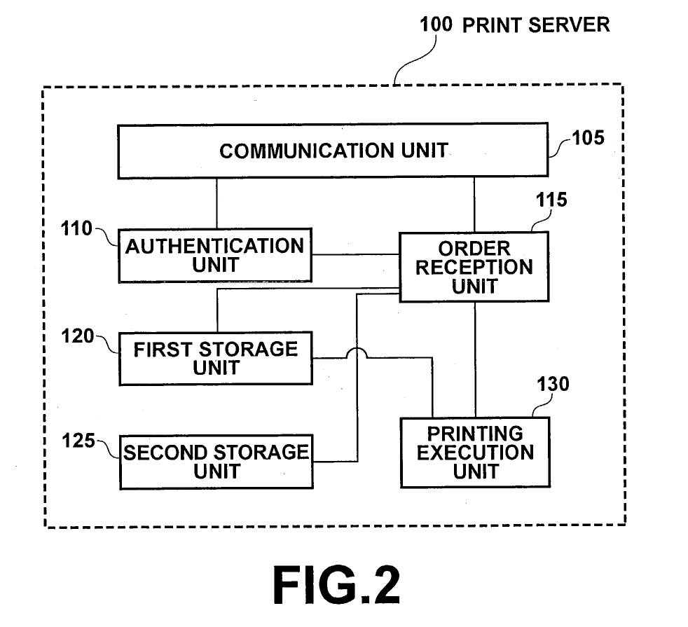

FIG. 2 is a block diagram showing a configuration of the print server 100 used in the printing service system shown in FIG. 1. As shown in FIG. 2, the print server 100 comprises a communication unit 105, an authentication unit 110, an order reception unit 115, a first storage unit 120, a second storage unit 125, and a printing execution unit 130. The communication unit 105 carries out communication with the cellular phone 10 and the printing apparatuses 20 via the Internet 30. The authentication unit 110 authenticates a user who accesses the server 100 from the cellular phone 10 via the communication unit 105. The order reception unit 115 displays an image represented by the image data stored in the first storage unit 120 in relation to the user (in relation to the phone number of the cellular phone 10, in this case) to the user authenticated by the authentication unit 110 (that is, on the cellular phone 10 of the user). The order reception unit 115 then receives a printing order request regarding the image data and a confirmation instruction regarding the printing order request that are input by the user from the cellular phone 10. The order reception unit 110 also stores in the second storage unit 125 the printing order request or requests (hereinafter referred to as the printing order requests) that have been input, and reads from the second storage unit 125 the printing order requests whose confirmation instruction has been input so that the printing order requests can be sent to the printing execution unit 130. The first storage unit 120 stores a password and the image data of the user in relation to the phone number of the cellular phone 10. The second storage unit 125 stores the printing order requests and information representing whether or not the confirmation instruction has been input regarding the printing order requests (hereinafter referred to as confirmation state information). The printing execution unit 130 sends the image data specified in the printing order requests sent from the order reception unit 115, a print quantity, a size, and presence or absence of eclipse that have been set regarding the image data to a corresponding one of the mini-laboratories as an agency included in the printing order requests (hereinafter referred to as the mini-laboratory). The order reception unit 115 searches the second storage unit 125 according to the confirmation state information for the printing order requests whose confirmation instruction has not been input from the cellular phone 10 whose user has been authenticated by the authentication unit 110. In the case where the printing order requests whose confirmation instruction has not been input are not present in the second storage unit 125, the order reception unit 115 displays the image represented by the image data of the user stored in the first storage unit 120, and receives an input of a printing order request by the user. In the case where the printing order requests whose confirmation instruction has not been input are found, the order reception unit 115 collectively displays the printing order requests.

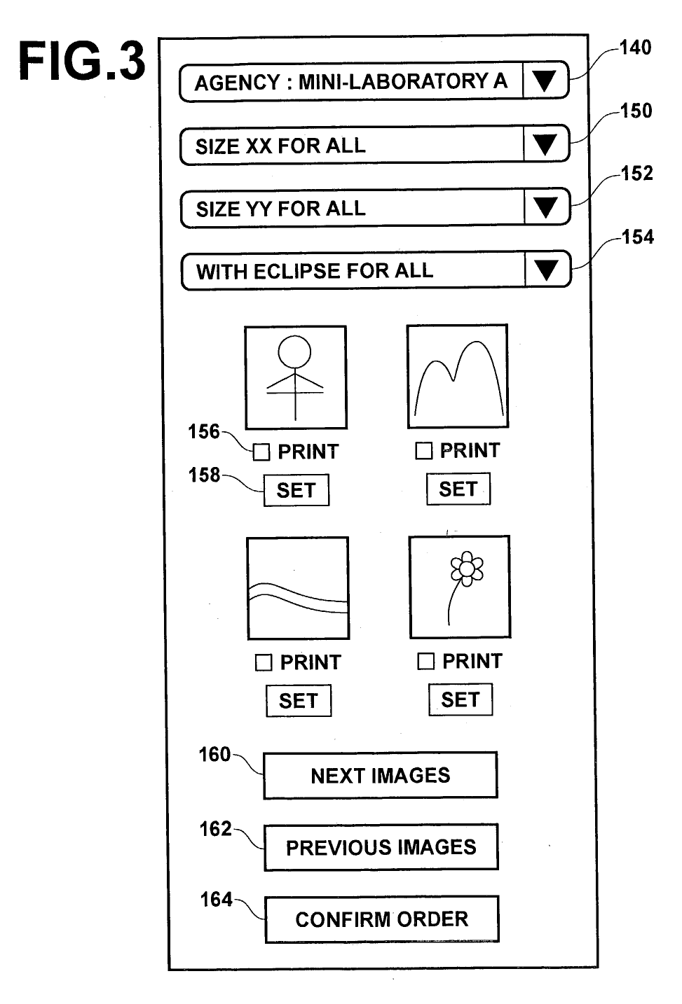

The operation of the order reception unit 115 will be explained in detail, with reference to FIGS. 3 to 5.

FIG. 3 shows an order reception page displayed on the cellular phone 10 whose user has been authenticated by the authentication unit 110 and which has no unconfirmed printing order request in the second storage unit 125. As shown in FIG. 3, four images of the user of the cellular phone 10 are shown in the order reception page at a time, and “Print” check boxes 156 and “Set” buttons 158 are shown under the respective images. When the user selects one of the check boxes 156, the image corresponding to the selected check box is specified as an image to be printed. A print size input box 150, a print quantity input box 152, and an eclipse setting input box 154 are also shown on top of the page. When the user selects from a menu of each of the input boxes, the print size, the print quantity, and presence or absence of eclipse can be set for all the images whose check boxes 156 have been selected. Likewise, by selecting the agency from a menu in an agency specification input box 140, the mini-laboratory at which the user receives a print or prints can be specified.

The agency specification input box 140, the print size input box 150, the print quantity input box 152, and the eclipse setting input box 154 are commonly used for all the images to be printed (that is, for all the images whose “Print” check boxes 156 have been selected). The “Set” buttons 158 for the respective images are used individually for the corresponding images. The setting for individual image has the priority over the setting for all the images.

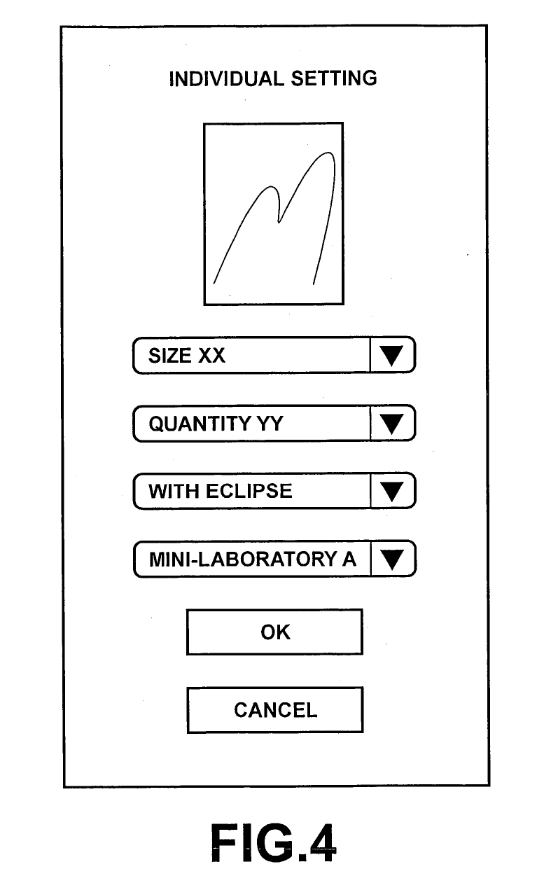

FIG. 4 shows an individual setting page displayed by the order reception unit 115 when one of the “Set” buttons 158 is selected. As shown in FIG. 4, the user can set the print size, the print quantity, the presence or absence of eclipse, and the agency for the corresponding image. When an “OK” button is selected, the input for the corresponding image is completed, and the order reception unit 115 changes the individual setting page to the order reception page shown in FIG. 3. When a “Cancel” button is selected, the input for the corresponding image is cancelled, and the order reception unit 115 changes the individual setting page to the order reception page. For the image whose input has been cancelled, the common setting in the order reception page is adopted.

When a “Next Images” button 160 or a “Previous Images” button 162 at the bottom of the page in FIG. 3 is selected in the order reception page, the order reception unit 115 displays the following or previous four images, in order to receive an input of a printing order request regarding the displayed images.

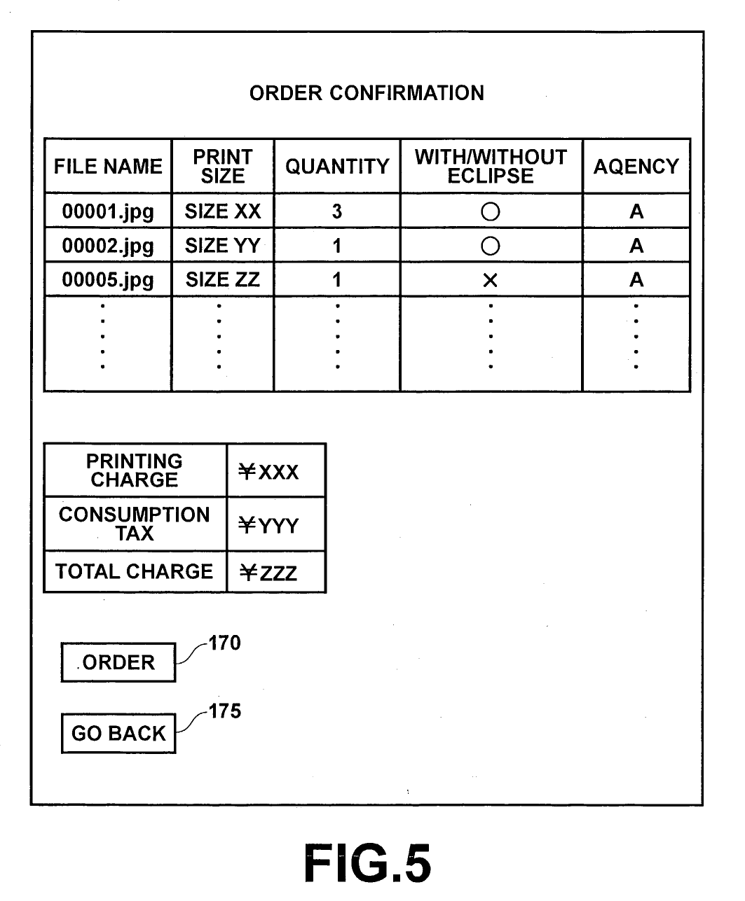

When a “Confirm Order” button 164 is selected in the order reception page in FIG. 3, the order reception unit 115 displays an order confirmation page shown in FIG. 5 to collectively show the printing order requests input by the user. The user can confirm the printing order requests that have been set by viewing this page. When the user selects an “Order” button 170, the printing order requests are confirmed. If the user selects a “Go Back” button 175, the order reception unit 115 displays the order reception page shown in FIG. 3 again so that the user can input the setting again.

Selecting the “Order” button 170 in the order confirmation page refers to confirming the printing order requests by the order reception unit 115 in the print server 100 in this embodiment.

The order reception unit 115 stores the printing order requests that have been input up to the present in the second storage unit 125 with the confirmation state information representing “unconfirmed” state until the “Order” button 170 is selected.

The order reception unit 115 enables the user to continue setting the printing order requests that have not been confirmed by collectively displaying the order confirmation page on the cellular phone 10 whose user has been authenticated by the authentication unit 110 and which has the printing order requests without the confirmation instruction retained in the second storage unit 125.

If the printing order requests are confirmed by selection of the “Order” button 170 in the order conformation page, the order reception unit 115 changes the confirmation state information for the printing order requests stored in the second storage unit 125 to “confirmed”, and sends the printing order requests to the printing execution unit 130.

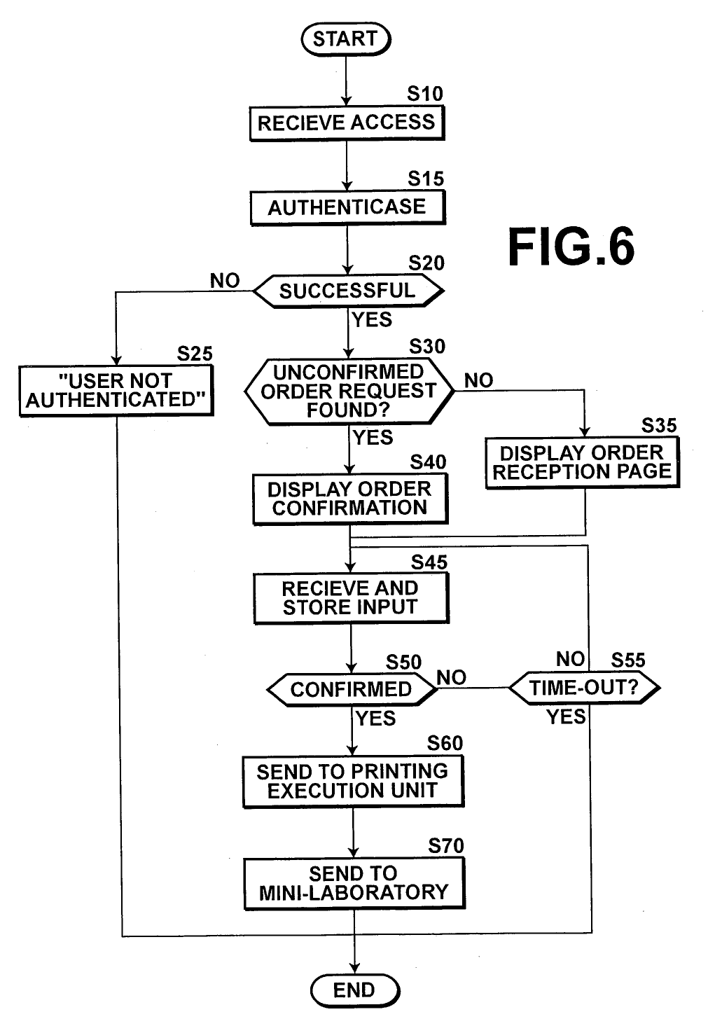

FIG. 6 is a flow chart showing the operation of the print server 100 in the printing service system in this embodiment. The print server 100 receives an access from the cellular phone 10 by using the communication unit 105 (Step S10). The authentication unit 110 obtains the phone number of the cellular phone 10 in access thereto, and prompts the user of the cellular phone 10 to input the password in order to carry out user authentication (Step S15). If the password input by the user agrees with the password for the phone number of the cellular phone 10 stored in the first storage unit 120 (Step S20: Yes), the user authentication is judged to have been carried out successfully. Therefore, the procedure goes to Step S30. In the case where the password input by the user does not agree with the password stored for the cellular phone number in the first storage unit 120 (Step S20: No), a message “User Not Authenticated” is displayed (Step S25) and the procedure ends.

The order reception unit 115 searches the second storage unit 125, based on the phone number of the cellular phone 10, for confirming whether or not unconfirmed printing order requests are stored regarding the phone number of the cellular phone 10 (Step S30). If no unconfirmed order request is stored (Step S30: No), the order reception page (an initial page wherein no information has been input, in this case) is displayed (Step S35) to receive an input of a printing order request (Step S45). In the case where the unconfirmed printing order requests are found (Step S30: Yes), the order conformation page wherein the unconfirmed order requests are collectively shown as in FIG. 5 is displayed (Step S40). By selection of the “Go Back” button 175 in this order confirmation page, the order reception page (wherein a portion of information has already been input, unlike the order reception page displayed at Step S35) is displayed, and the order reception unit 115 receives an input by the user regarding the printing order requests to be changed or added (Step S45). While receiving the input of the printing order requests by the user, the order reception unit 115 stores the printing order requests in the second storage unit 125 with the “unconfirmed” state confirmation information attached thereto. The order reception unit 115 updates the unconfirmed printing order requests stored in the second storage unit 125 (Step S45) each time the printing order requests are changed, until the “Order” button 170 in the order confirmation page is selected to confirm the orders. In the case where the connection between the print server 100 and the cellular phone 10 is disconnected or the time of connection interruption exceeds a predetermined time (Step S55: Yes) before the printing order requests are confirmed, the order reception unit 115 ends the procedure.

In the case where the user completes inputting of the printing order requests and selects the “Order” button 170 in the order confirmation page to confirm the order requests (Step S50: Yes), the order reception unit 115 sends the confirmed printing order requests to the printing execution unit 130, and changes the confirmation state information regarding the printing order requests from “unconfirmed” to “confirmed” in the second storage unit 125 (Step S60). The printing execution unit 130 reads the image data to be printed from the first storage unit 120, based on the printing order requests sent from the order reception unit 115. The printing execution unit 130 then sends the image data and the printing order requests to the mini-laboratory specified in the printing order requests (Step S70) to end the procedure.

The printing apparatus 20 in the mini-laboratory prints the image data according to the printing order requests regarding the image data.

As has been described above, according to the printing service system in this embodiment, the print server 100 stores the printing order requests that have not been confirmed. Therefore, even if a connection between the print server 100 and the cellular phone 10 is disconnected due to a phone call or the like during an input of a printing order request by the user from the cellular phone 10, the printing order requests that have been input can be provided when the user accesses again. Therefore, the user does not need to input the same printing order requests again, which is convenient.

Although a preferable embodiment of the server of the present invention has been explained above, the present invention is not limited to the embodiment described above. Many modifications can be made to the user authentication method, the items of printing order request, the order reception page, the order confirmation page, and the like, within the scope of the present invention.

For example, the print server 100 in the printing service system shown in FIG. 1 prints the image data by sending the image data to the mini-laboratory. However, the image data may be stored in a hard disc or the like and provided to the printing apparatus 20 of the mini-laboratory upon regular inquiry by the printing apparatus 20.

Furthermore, the second storage unit 125 in the print server 100 stores the printing order requests with the state confirmation information. However, only the unconfirmed printing order requests may be stored.

The server of the present invention is not limited to the print server that carries out the printing order reception procedure. The server can be used as a server that carries out any order reception procedure involving a cellular phone.

What is claimed is:

1. A server for providing an order reception service to a mobile terminal, the server comprising:
connection means for connecting with the mobile terminal via a network;
reception means for receiving an order request and a confirmation instruction regarding the order request input by a user via the mobile terminal connected by the connection means;
unconfirmed order request retaining means for retaining the content of the order request of the user until the confirmation instruction regarding the order request is input by the user via the mobile terminal; and
order reception means for receiving an order according to the content of the order request confirmed by the confirmation instruction input by the user via the mobile terminal, wherein the order reception means comprises:
search means for checking whether or not the unconfirmed order request retaining means has an order request that has not been confirmed by the user of the mobile terminal upon connection with the mobile terminal established by the connection means; and
unconfirmed order request retrieving means for providing the user via the mobile terminal with the order request that has not been confirmed by reading the order request of the user retained in the unconfirmed order request retaining means in the case where the unconfirmed order request retaining means has the order request of the user.

2. A server as defined in claim 1, further comprising storage means for storing image data, wherein
the order request is a printing order request regarding the image data stored in the storage means.
